(19) United States
(12) Patent Application Publication
(10) Pub. No.: US 2025/0354761 A1
(43) Pub. Date: Nov. 20, 2025

(54) HEAT DISSIPATION DEVICE WITH REINFORCED STRUCTURE

(71) Applicant: NIDEC CHAUN-CHOUNG TECHNOLOGY CORPORATION, NEW TAIPEI CITY (TW)

(72) Inventors: Man-Cheng WONG, NEW TAIPEI CITY (TW); Wen-Lung LIU, NEW TAIPEI CITY (TW)

(21) Appl. No.: 19/098,134

(22) Filed: Apr. 2, 2025

(30) Foreign Application Priority Data
May 14, 2024 (TW) 113117798

(51) Int. Cl. F28D 15/04

(52) U.S. Cl. CPC F28D 15/04

(57) ABSTRACT

A heat dissipation device with reinforced structure having a vapor chamber, a reinforced member, and a plurality of fixing members is provided. The vapor chamber has a heated surface and a combined surface defined a plurality of fixing holes. The reinforced member has a cover portion and two flanks extended from the cover portion. The cover portion is located to the combined surface and defines a plurality of through holes on the flanks. The fixing member has a penetration portion, an end head, and a riveting portion. The penetration portions pass through the through holes and the fixing holes to expose the end heads outside the fixing holes. The reinforced member further has an annular flange arranged in the through hole. The penetration portion defines an annular groove corresponding to the annular flange. The riveting portions are buried in the through holes and located outside of the annular flanges.

### BACKGROUND

### Technical Field

The present disclosure relates to a heat dissipation device, particularly to a heat dissipation device with reinforced structure.

### Description of Related Art

Existing vapor chamber cooling devices mainly use a vapor chamber to contact with a heat source. Since the vapor chamber often needs to be equipped with components such as fins or heat pipes to achieve a good condensation effect, the existing vapor chamber is usually combined with the above components by welding.

However, although the vapor chamber may be welded to other components, a structural strength thereof is often insufficient. In addition, the vapor chamber is also easily deformed or even damaged by factors such as collision after being welded together with other components. As a result, the existing vapor chamber cooling devices still have insufficient structural strength after assembly.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to provide a heat dissipation device with reinforced structure, which is comprised of a reinforced member rivetted to a vapor chamber, to enhance a structural strength of the vapor chamber and be conducive to assemble a plurality of heat pipes or arranging a fin group.

To accomplish the aforementioned objective, the present disclosure provides a heat dissipation device with reinforced structure having a vapor chamber, a reinforced member, and a plurality of fixing members. The vapor chamber has a heated surface and a combined surface opposite to the heated surface. The combined surface has a plurality of fixing holes defined on a periphery of the vapor chamber. The reinforced member has a cover portion and two flanks extended from the cover portion. The cover portion is located on the combined surface of the vapor chamber and defines a plurality of through holes corresponding to each of the fixing holes on each of the flanks. Each of the fixing members has a penetration portion, an end head located on an end of the penetration portion, and a riveting portion located on the other end of the penetration portion. Each of the fixing members passes through each of the through holes and each of the fixing holes through each of the penetration portions thereof to expose each of the end heads outside each of the fixing holes. The reinforced member further has an annular flange arranged in each of the through holes. Each of the penetration portions defines an annular groove corresponding to each of the annular flanges. Each of the riveting portions is buried in each of the through holes and located outside of each of the annular flanges.

### BRIEF DESCRIPTION OF THE DRAWINGS

FIG. 1 is an exploded view of the present disclosure;

FIG. 2 is an exploded view of the present disclosure arranged the fin group;

FIG. 3 is a perspective appearance view of the present disclosure arranged the fin group;

FIG. 4 is a cross-sectional side view of the vapor chamber and the reinforced member of the present disclosure; and

FIG. 5 is a partial cross-sectional side view of the present disclosure.

### DETAILED DESCRIPTION

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

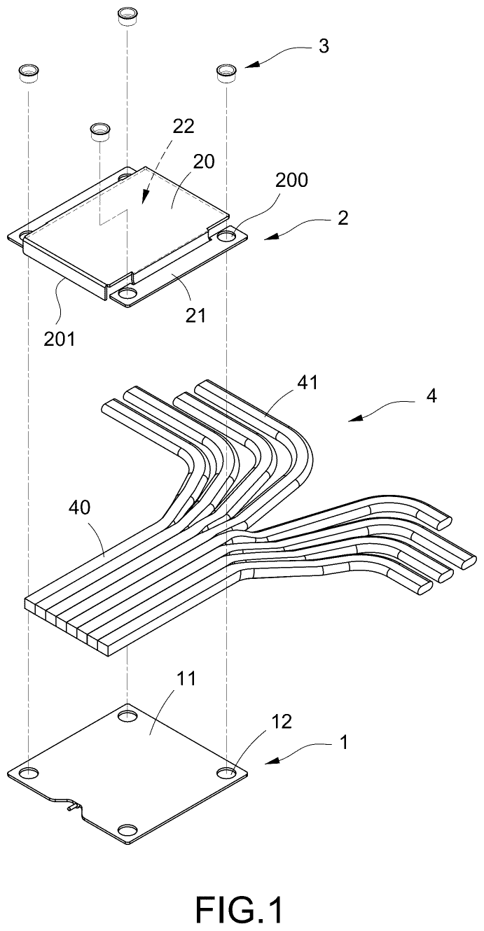

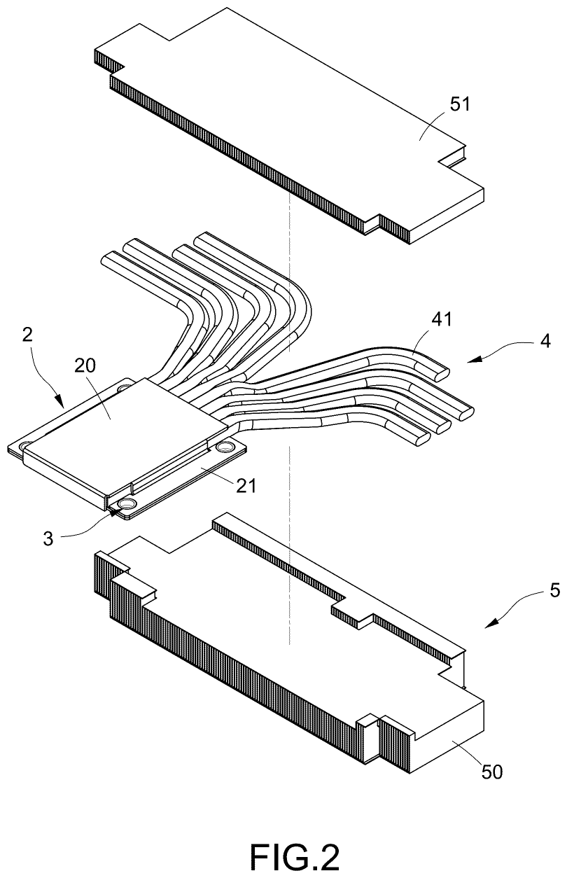

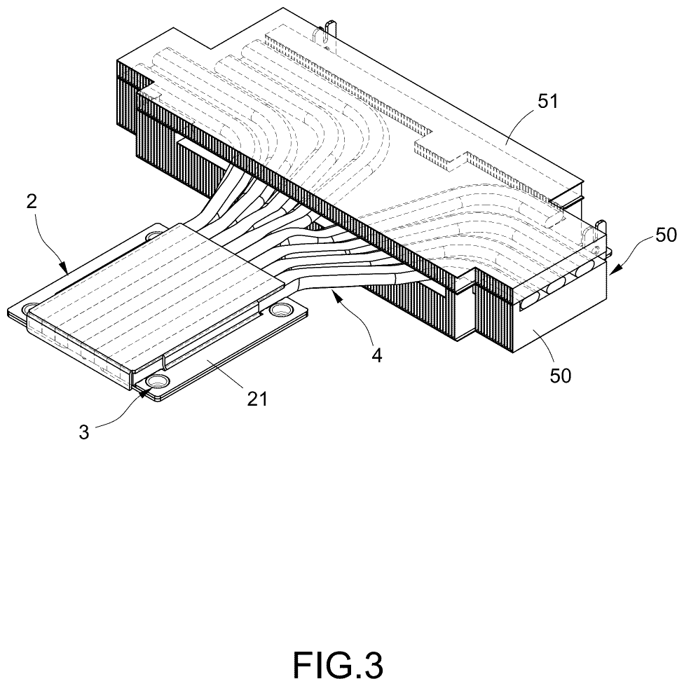

Please refer to FIG. 1, FIG. 2, FIG. 3, which are respectively the exploded view of the present disclosure, the exploded view of the present disclosure arranged the fin group, and the perspective appearance view of the present disclosure arranged the fin group. The present disclosure provides a heat dissipation device with reinforced structure including a vapor chamber 1, a reinforced member 2, and a plurality of fixing members 3.

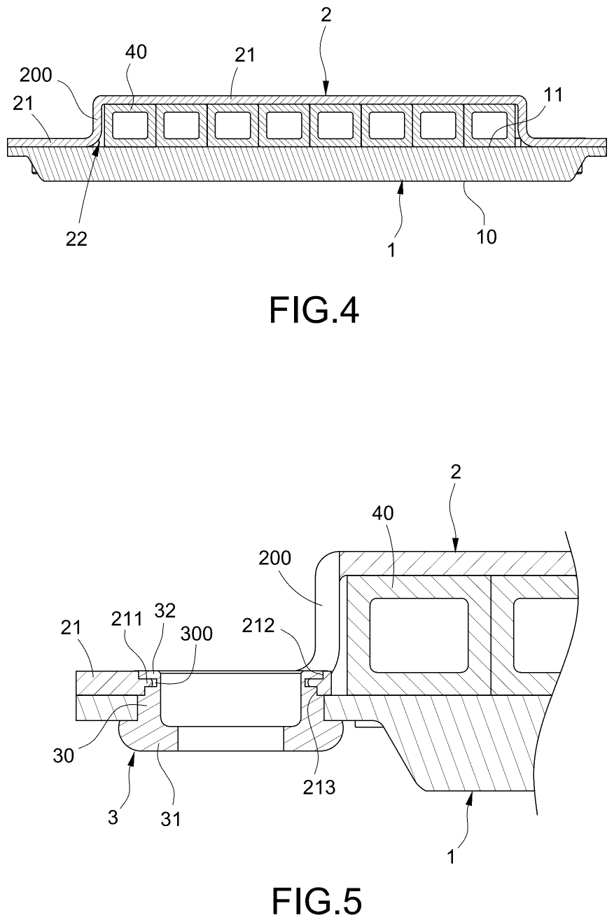

As shown in FIG. 4, the vapor chamber 1 has a heated surface 10 and a combined surface 11. The heated surface 10 is used to contact a heat source (not shown in figures). The combined surface 11 is opposite to the heated surface 10. The combined surface 10 has a plurality of fixing holes 12 defined on a periphery of the vapor chamber 1. In detail, each of the fixing holes 12 is located on at least one sealing area of the vapor chamber 1. In the embodiment, the vapor chamber 1 has two sealing areas on opposite sides thereof, and each of the sealing areas is corresponding to each of the flanks 21 describing later.

The reinforced member 2 is formed by stamping a metal sheet. The material of the metal sheet may be steel with high carbon content, such as SK7. The reinforced member 2 has a cover portion 20 and two flanks 21 extended from the cover portion 20. The cover portion 20 is located on the combined surface 11 of the vapor chamber 1. The cover portion 20 has a plurality of through holes 210 defined on each of the flanks 21. Each of the through holes 210 is correspondingly located above each of the fixing holes 12.

As shown in FIG. 5, each of the fixing members 3 passes through each of the through holes 210 and each of the fixing holes 12. Each of the fixing members 3 has a penetration portion 30, an end head 31 located on an end of the penetration portion 30, and a riveting portion 32 located on the other end of the penetration portion 30. Each of the fixing members 3 passes through each of the through holes 210 and each of the fixing holes 12 through each of the penetration portions 30 thereof, so as to expose each of the end heads 31 outside each of the fixing holes 12. An annular flange 211 is arranged in each of the through holes 210. Each of the penetration portions 30 defines an annular groove 300 corresponding to each of the annular flanges 211. Each of the riveting portions 32 is buried in each of the through holes 210 and located outside of each of the annular flanges 211. In detail, each of the flanks 21 has an outer ring groove 212 defined on an outer side of the corresponding annular groove 211. Each of the riveting portions 32 is buried in each of the outer ring grooves 212 such that each of the riveting portions 32 may be not exposed outside a surface of each of the flanks 21. Each of the flanks 21 has an inner ring groove 213 defined on an inner side of the corresponding annular groove 211. Each of the inner ring grooves 213 is used to position each of the penetration portions 30 when each of the penetration portions 30 passes through each of the fixing holes 12.

Details are provided as follows. Each of the fixing members 3 may be a rivet. Before each of the fixing members 3 passes through each of the through holes 210 and each of the fixing holes 12, each of the riveting portions 32 has a same outer diameter as each of the penetration portions 30. After each of the penetration portions 30 is inserted in each of the fixing holes 12 to make each of the riveting portions 32 to expose outside each of the through holes 210, each of the riveting portions 32 is rivetted to be buried in each of the outer ring grooves 212.

In addition, please refer to FIG. 1 and FIG. 4 again. The cover portion 20 and each of the flanks 21 may together form a clamping space 22, such that a plurality of heat pipes 4 may be arranged on the combined surface 11 of the vapor chamber 1 in parallel. The reinforced member 2 has two bending portions 200 respectively arranged between the cover portion 20 and each of the flanks 21, so as to form a step between the cover portion 20 and the flanks 21 to form the clamping space 22. Furthermore, each of the heat pipes 4 has a heated section 40 and a condensation section 41 extended from the heat section 40 in one-piece form. A cross section of each of the heated sections 40 is square or rectangular, and each of the e heated sections 40 is arranged in parallel in the clamping space 22 between the cover portion 20 and the vapor chamber 1. Therefore, the reinforced member 2 may be combined with the vapor chamber 1 by each of the fixing members 3, so as to fix each of the heat pipes 4 between the reinforced member 2 and the vapor chamber 1 to extend heat transfer and heat exchange of the vapor chamber 1. In addition, the reinforced member 2 further has a stopping portion 201 extended from a side of the cover portion 20 away from each of the condensation sections 41 to cover each of the heated sections 40.

As shown in FIG. 2 and FIG. 3, the heat dissipation device with reinforced structure of the present disclosure further includes at least one fin group 5. The fin group 5 is arranged on the condensation sections 41 of the heat pipes 4. In the embodiment, the fin group 5 includes a lower fin group 50 and an upper fin group 51. The lower fin group 50 and the upper fin group 51 together clamp each of the condensation sections 41 of each of the heat pipes 4 to help each of the condensing sections 41 to cool down, so as to assist the vapor chamber 1 in heat exchange.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A heat dissipation device with reinforced structure, comprising:
a vapor chamber, comprising a heated surface and a combined surface opposite to the heated surface, the combined surface comprising a plurality of fixing holes defined on a periphery of the vapor chamber;
a reinforced member, comprising a cover portion and two flanks extended from the cover portion, the cover portion located on the combined surface of the vapor chamber and defined a plurality of through holes corresponding to each of the fixing holes on each of the flanks, and
a plurality of fixing members, respectively comprising a penetration portion, an end head located on an end of the penetration portion, and a riveting portion located on the other end of the penetration portion, each of the fixing members passing through each of the through holes and each of the fixing holes through each of the penetration portions thereof to expose each of the end heads outside each of the fixing holes,
wherein the reinforced member further comprises an annular flange arranged in each of the through holes, each of the penetration portions defines an annular groove corresponding to each of the annular flanges, each of the riveting portions is buried in each of the through holes and located outside of each of the annular flanges.

2. The heat dissipation device with reinforced structure according to claim 1, wherein each of the fixing holes is located on at least one sealing area of the vapor chamber.

3. The heat dissipation device with reinforced structure according to claim 1, wherein the reinforced member is formed by stamping a metal sheet.

4. The heat dissipation device with reinforced structure according to claim 3, wherein a material of the metal sheet is steel.

5. The heat dissipation device with reinforced structure according to claim 1, wherein each of the flanks comprises an outer ring groove defined on an outer side of the corresponding annular groove, each of the riveting portions is buried in each of the outer ring grooves.

6. The heat dissipation device with reinforced structure according to claim 1, wherein each of the flanks comprises an inner ring groove defined on an inner side of the corresponding annular groove.

7. The heat dissipation device with reinforced structure according to claim 1, wherein the cover portion and each of the flanks together form a clamping space.

8. The heat dissipation device with reinforced structure according to claim 7, further comprising a plurality of heat pipes, wherein each of the heat pipes comprises a heated section and a condensation section extended from the heat section in one-piece form, each of the heated sections is arranged on the combined surface in parallel and accommodated in the clamping space.

9. The heat dissipation device with reinforced structure according to claim 8, wherein the reinforced member comprises two bending portions respectively arranged between the cover portion and each of the flanks.

10. The heat dissipation device with reinforced structure according to claim 8, further comprising a fin group, wherein the fin group is arranged on the condensation section.
